(19) United States
(12) Patent Application Publication
(10) Pub. No.: US 2026/0158750 A1
(43) Pub. Date: Jun. 11, 2026

(54) AIRCRAFT COMPOSITE PART MANUFACTURING PROCESS

(71) Applicant: Airbus Operations Limited, Bristol (GB)

(72) Inventors: Mohammed AL-TAYAWE, Bristol (GB); John HOBDAY, Bristol (GB)

(21) Appl. No.: 19/413,106

(22) Filed: Dec. 9, 2025

(30) Foreign Application Priority Data
Dec. 9, 2024 (GB) 2417992.1

(51) Int. Cl. B29C 70/34; B29K 105/00; B29K 105/26; B29K 307/04; B29L 31/30

(52) U.S. Cl. CPC B29C 70/345; B29K 2105/251; B29K 2105/26; B29K 2307/04; B29L 2031/3076

(57) ABSTRACT

A method of manufacturing a composite aircraft part using recycled and virgin composite materials in a two part tool is disclosed.

### TECHNICAL FIELD

The present invention relates to a method of manufacturing a composite aircraft part from a combination of recycled and virgin composite materials.

### BACKGROUND

The manufacture and use of aircraft parts manufactured using a reinforcement material embedded in a resin matrix (“composite material”) has steadily increased in the last decades owing to the superior mechanical performance, corrosion resistance and customisability of such materials, with carbon, aramid or glass reinforcements combined most often with a polymer thermoset or thermoplastic resin matrix materials being the most common.

One area where composite materials perform less favourably than their metallic alternatives is their recyclability. Current methods to recycle composite material require considerable effort and energy to separate the reinforcement material from the resin material, most often using chemical or thermal means. Not only is this costly, but it may result in recycled reinforcement material that has lower mechanical performance than when the reinforcement material was new. These factors reduce the re-usability of recycled composite materials for composite aircraft parts.

Aspects and embodiments of the present invention seek to mitigate these issues by providing a means to manufacture a composite using recycled composite materials in combination with virgin composite materials. Recycled composite materials in this context refers to materials used in the manufacture of existing products that have been converted into raw materials for new products, whereas virgin material refers to material that is used for the first time and in the manufacture of new products.

### SUMMARY

A first aspect of the present invention provides a method of manufacturing a composite part, comprising the steps of:
providing a forming tool with a first tool part and a corresponding second tool part, wherein each tool part further comprises a tool face that provides a composite part forming cavity with a pre-determined composite part shape when the first tool part and corresponding second tool part are moved towards each other to a predetermined compression position;
providing a layup of recycled composite material and virgin composite material on the tool face of the first tool part;
infusing the recycled composite material and virgin composite material with a curable liquid resin material;
moving the first tool part and corresponding second tool part towards each other to the predetermined position in order to compress the recycled composite material and virgin composite material into the predetermined composite part shape;
permitting the resin material to harden such that a composite part is formed; and,
releasing the composite part from the forming tooling.

The first tool part may be substantially concave in shape (sometimes referred to as a female mould tool) and the second corresponding part may be substantially convex (sometimes referred to as a male mould tool) in shape. Such a configuration may be preferable for composite forging where higher compression of the composite layup may be required.

The step of providing a lay-up may further comprise placing the virgin composite material in areas of the composite part forming cavity where the recycled composite material is not expected to conform to the predetermined composite part shape when the first tool part and corresponding second tool part are moved towards each other to the predetermined compression position. It may further comprise placing the virgin composite material in the composite part forming cavity at locations where the tool face of either the first tool part, or second corresponding tool part comprises a change in curvature. The placement of recycled composite material in areas of the layup where there is a relative change in curvature may result in voids due to the resistance of the recycled composite material to conforming to the tool part shape in these areas during compression and/or poor wetting of the recycled composite materials during the resin impregnation step of the manufacturing process. It may therefore be preferable to place the virgin composite material in such areas of the composite part forming cavity during the layup to enable sufficient compression and/or wetting of the layup.

The step of providing recycled composite material may comprise providing recycled chopped carbon fibre and resin material with a major dimension of each recycled particle is between 1-20 mm. Such material may be suited for forming smaller parts, or parts with complex features such as pad-ups, ribs or flanges, radii.

The recycled composite material may be recycled reinforcement material pre-impregnated with partially cured resin material. Such material may be the excess pre-preg virgin material that has exceeded its storage time and obtained as waste from another composite part manufacture process where the pre-preg is used. Such material may be in the form of unidirectional, woven, or chopped e-glass or carbon type fibers pre-impregated with resin, which may be desirable to use where higher mechanical properties or improved consolidation is required in areas of the layup.

Alternatively, the recycled composite material may be recycled reinforcement material impregnated with fully cured resin material. Such material may be recycled composite material in the form of aggregate obtained from the processing of composite aircraft parts taken out of service or otherwise scrapped. Such material is available in a wide variety of forms and compositions and is relatively inexpensive and easy to obtain in large quantities.

The step of providing virgin composite material may comprise providing virgin composite material with reinforcement fibres with a mean fibre length that is substantially less than as the recycled reinforcement material. Use of such a format of virgin composite material may be desirable to use where improved consolidation is required in areas of the layup such as around complex features of the layup or areas where changes in curvature in the layup occur.

Compression of the recycled composite material and virgin composite material in the predetermined composite part shape may be continuously applied after the step of infusing the cavity with curable liquid resin until the resin material hardens. Compressing the layup in such a way may ensure that the layup achieves the desired net shape while it may also ensure that the resin is forced into areas of the layup to ensure good consolidation and the avoidance of any voids in the final part. In addition, it may be desirable to apply compression in stages before and after infusion of the layup with resin, to consolidate the dry layup prior to infusion, thereby potentially avoiding voids by allowing the recycled composite material to align and conform better to the cavity shape.

A further step of removing excess resin and/or reinforcement material from the edges of the composite part may be provided to ensure that the part conforms with the required design shape of the part and to remove any out of tolerance edges. Such a step may also ensure that any sharp edges are removed.

A further aspect of the present invention provides a composite part manufactured using the method according to the first aspect of the present invention.

Yet a further aspect of the present invention provides an aircraft comprising a composite part according to the second aspect of the present invention.

### BRIEF DESCRIPTION OF THE DRAWINGS

Embodiments of the invention will now be described, by way of example only, with reference to the accompanying drawings, in which:

FIG. 1 is a schematic isometric view of an aircraft provided with a composite part manufactured according to an aspect of the present invention;

FIG. 2 is an isometric schematic view of the composite part of FIG. 1;

FIG. 3 shows steps in manufacturing the composite part of FIG. 2;

FIG. 4 shows a further optional step of manufacturing the composite part of FIG. 3.

### DETAILED DESCRIPTION

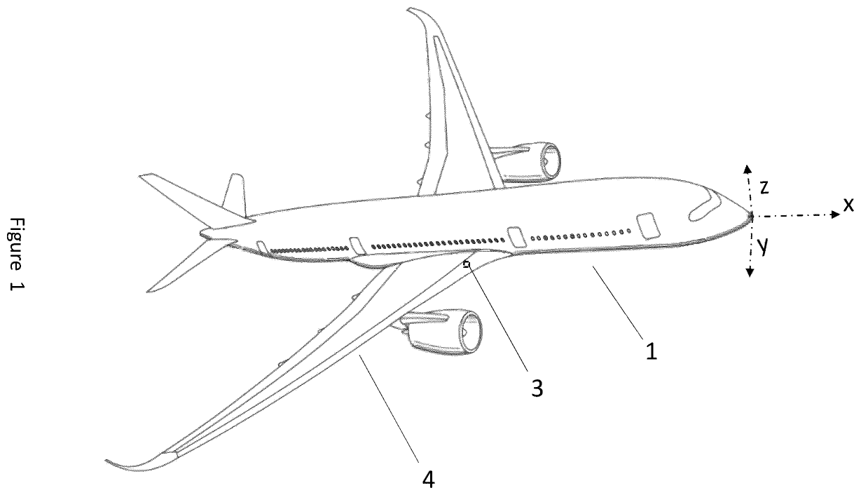

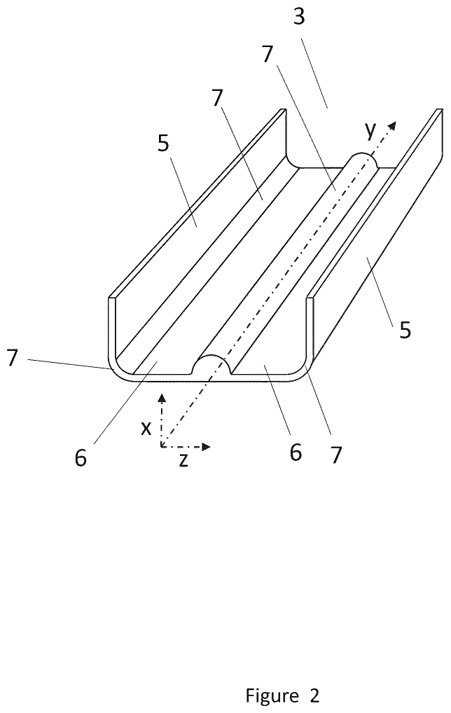

With reference to FIGS. 1 and 2, a commercial passenger aircraft is shown with a composite part 3 in the form of an electrical system installation bracket 3 which is installed at the leading edge area of the wing 4. The composite part 3 is formed from a mixture of composite materials in the form of recycled CFRP laminate material and virgin woven CFRP material using the manufacturing process according to the first aspect of the present invention. Three orthogonal reference axes for the aircraft 1 are also shown; an aircraft longitudinal axis X, a spanwise axis Y and vertical axis Z.

The recycled CFRP material is initially provided in an aggregate form that is obtained by a shredding and sorting process using existing decommissioned aircraft composite panels resulting in recycled CFRP pieces of random size no greater than 20 mm in length. The virgin CFRP material is in the form of chopped CFRP tows of varying lengths, but no greater than 20 mm.

The composite part 3 is elongated in shape in the spanwise direction Y with planar portion 7 in the form of a pair of planar flanges 5 and a planar web 6. The flanges 5 extend in the longitudinal direction X that are of similar size and spaced apart in the vertical Z direction. The planar flanges 5 are joined by a planar web portion 6 that provides this spacing and which also extends in the spanwise direction Y, as shown.

The part 3 has curved features 7 in the form of radius portions 7 that transition between the planar flanges 5 and web 6 and a longitudinal stiffener 7 that is provided on the web 6. In such areas a change in curvature exists from the substantially planar portions 5 of the composite part 3.

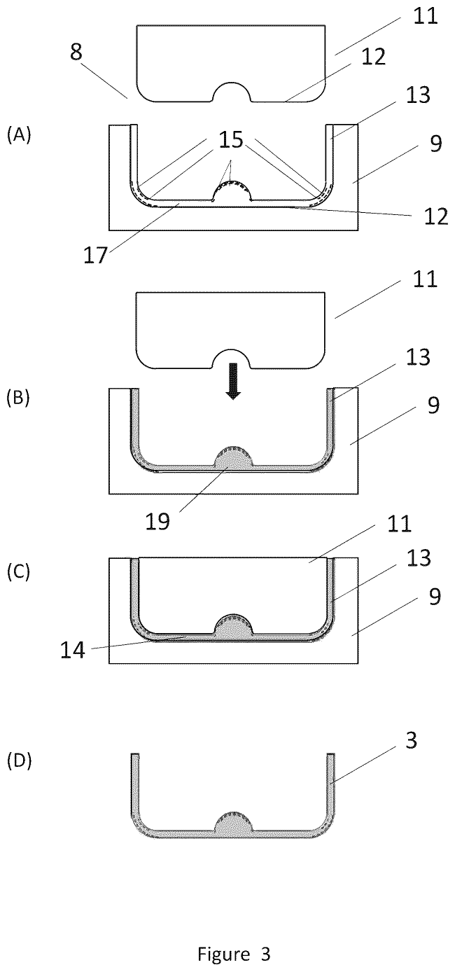

With reference to FIG. 3, the manufacturing process of the composite part 3 is shown in more detail. In step A, a forming tool 8 with a first tool part 9 and a corresponding second tool part 11 are provided. Each tool part 9, 11 comprises a tool face 12 that provides a composite part forming cavity 14 with a pre-determined composite part shape when the first tool part 9 and corresponding second tool part 11 are moved towards each other to a predetermined compression position (shown in step C). In step B, a layup 13 of recycled composite material and virgin composite material is laid up on the tool face 12 of the first tool part 9. The layup 13 may be in a partially or fully preassembled form external to the tool 8 prior to it being laid up against the tool face 12, or alternatively it may be laid up in layers at the tool face 12.

Once the layup 13 is in position, the layup 13 comprising the recycled composite material and virgin composite material is fully infused with a curable liquid thermoset resin material 19 as indicated by the change in shading of the layup 13. The resin may be manually applied or introduced by any other suitable means known in the art. The first tool part 9 and corresponding second tool part 11 are brought towards each other by controlled movement of the second tool part 11 as shown in step B to the predetermined position shown in step C, such that the virgin composite material 15 and recycled composite material 17 in the layup 3 is compressed into the predetermined shape of the cavity 14 which substantially matches the intended net design shape of the composite part 3.

The compression action shown between step B and C consolidates the layup 13. This leads to movement of relatively stiff recycled composite material and deformation of virgin composite material within the layup, the latter being particularly relevant in areas where curved features 7 are present in the part. For this reason, the use of virgin composite material 15 is concentrated in the layup 13 in these areas as shown along with recycled composite material 17, whereas the planar portions 5, 6 of the layup 13 comprise primarily of recycled composite material 17. Such a composition of the layup 13 leads to a reduction of defects in the composite part 3 in areas of the curved features 7 such as voids, or resin pockets, that would otherwise result from poor consolidation and/or poor infusion of the resin into the layup 13. Once the layup 13 is infused and compressed, the resin is permitted to set and harden such that a composite part 3 is formed, after which the second tool part 11 is withdrawn from the first tool part 9 so that the composite part 3 can be removed from the tool 8, as shown in step D.

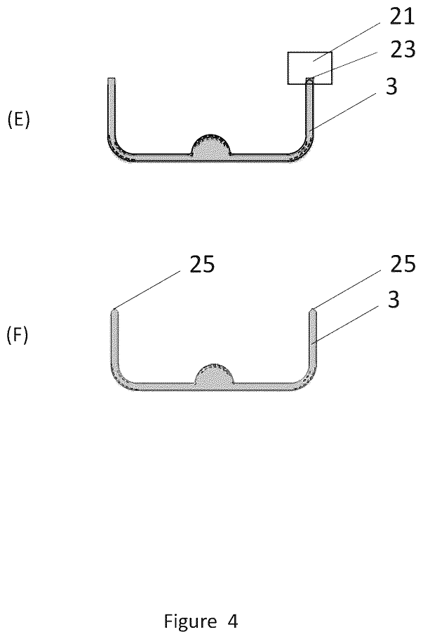

With reference to FIG. 4, a further optional step E of machining the distal end 23 of each flange 5 is provided using a cutting tool 21 with a cutting operation that is configured to remove excess material such as resin and/or sharp edges from the edge of the flanges 5 and leave a smooth edge 23 of the final part 3 shown in step F.

Although the invention has been described above with reference to one or more preferred examples or embodiments, it will be appreciated that various changes or modifications may be made without departing from the scope of the invention as defined in the appended claims.

Although the invention has been described above mainly in the context of a fixed-wing aircraft application, it may also be advantageously applied to various other applications, including but not limited to applications on vehicles such as helicopters, drones, trains, automobiles and spacecraft.

Where the term “or” has been used in the preceding description, this term should be understood to mean “and/or”, except where explicitly stated otherwise. This listing of claims will replace all prior versions, and listings, of claims in the application.

1. Method of manufacturing a composite part, comprising the steps of:
providing a forming tool with a first tool part and a corresponding second tool part, wherein each tool part further comprises a tool face that provides a composite part forming cavity with a pre-determined composite part shape when the first tool part and corresponding second tool part are moved towards each other to a predetermined compression position;
providing a layup of recycled composite material and virgin composite material on the tool face of the first tool part;
infusing the recycled composite material and virgin composite material with a curable liquid resin material;
moving the first tool part and corresponding second tool part towards each other to the predetermined position in order to compress the recycled composite material and virgin composite material into the predetermined composite part shape;
permitting the resin material to harden such that a composite part is formed; and
releasing the composite part from the forming tooling.

2. Method of claim 1, wherein the first tool part is substantially concave in shape and the second corresponding part is substantially convex in shape.

3. Method of claim 1, wherein the step of providing a lay-up further comprises placing the virgin composite material in areas of the composite part forming cavity where the recycled composite material is not expected to conform to the predetermined composite part shape when the first tool part and corresponding second tool part are moved towards each other to the predetermined compression position.

4. Method of claim 1, wherein the step of providing a lay-up further comprises placing the virgin composite material in the composite part forming cavity at locations where the tool face of either the first tool part or second corresponding tool part comprises a change in curvature.

5. Method of claim 1, wherein the step of providing recycled composite material comprises providing recycled chopped carbon fibre and resin material with a major dimension of each recycled particle is between 1-20 mm.

6. Method of claim 6, wherein the recycled composite material is recycled reinforcement material pre-impregnated with partially cured resin material.

7. Method of claim 5, wherein the recycled composite material is recycled reinforcement material impregnated with fully cured resin material.

8. Method of claim 5, wherein the step of providing virgin composite material comprises providing virgin composite material with reinforcement fibres with a mean fibre length that is substantially less than the recycled reinforcement material.

9. Method of claim 1, wherein compression of the recycled composite material and virgin composite material in the predetermined composite part shape is continuously applied after the step of infusing the cavity with curable liquid resin until the resin material hardens.

10. Method of claim 1, further comprising the step of removing excess resin material from the edges of the composite part.

11. An aircraft composite part manufactured using the method of claim 1.

12. An aircraft comprising an aircraft composite part according to claim 11.
